(19) United States
(12) Patent Application Publication
(10) Pub. No.: US 2007/0106883 A1
(43) Pub. Date: May 10, 2007

(54) Efficient Streaming of Un-Aligned Load/Store Instructions that Save Unused Non-Aligned Data in a Scratch Register for the Next Instruction

(76) Inventor: Jack H. Choquette, Mountain View, CA (US)

Correspondence Address: STUART T AUVINEN, 429 26TH AVENUE, SANTA CRUZ, CA, 95062-5319, US

(21) Appl. No.: 11/164,011

(22) Filed: Nov. 7, 2005

(51) Int. Cl. G06F 9/44

(52) U.S. Cl. 712/225

(57) ABSTRACT

A memory block with any source alignment is streamed into general-purpose registers (GPRs) as aligned data using a streaming load instruction. A streaming store instruction reads the aligned data from the GPRs and writes the data into memory with any destination alignment. Data is streamed from any source alignment to any destination alignment. Memory accesses are aligned to memory lines. The data is rotated using the offset within a memory line of the base address. The rotated data is stored in a scratch register for use by the next streaming load instruction. Rotated data just read from memory is combined with rotated data in the scratch register read by the last streaming load instruction to generate result data to load into the destination GPR. Streaming condition codes are set when the block's end is detected to disable future streaming instructions. Aligned memory accesses at full bandwidth read the un-aligned block.

### FIELD OF THE INVENTION

This invention relates to central processing unit (CPU) processors, and more particularly to load and store instructions.

### BACKGROUND OF THE INVENTION

Many of today's advanced computing systems contain a microprocessor or other central processing unit (CPU) that executes a set of instructions such as x86, MIPS, and many others and their variants. The instruction-set architecture defines the format of the instructions that programs can execute. A typical instruction has an opcode that is a field that contains a binary number that identifies the operation to be performed by the instruction. Different binary values in the opcode field select different kinds of instructions, such as a load that reads from a memory, an add, multiply, or other arithmetic or Boolean operation, branches, stores (writes) to memory, and many others.

Instructions also contain other fields that may further define the operation performed. Input and output operands are often specified by operand fields. Operands may be values stored in general-purpose registers (GPR) or at an address formed from a value in a GPR. Testing and setting of condition codes or special registers may also be defined in the instruction.

Some computer architectures attempt to simplify their pipelines to allow for faster instruction execution. For example, loads and stores may restrict the possible addresses that may be read or written from memory. Load/store addresses may be required to be aligned to boundaries of memory lines. For example, a memory line of 8 bytes may only allow accesses that start and end on 8-byte boundaries that are aligned with the 8-byte memory lines. Individual bytes in the line may have to be extracted by execution of additional instructions after an 8-byte aligned load.

Oftentimes large blocks or arrays of data may need to be accessed, stored, copied, or moved. The data blocks may or may not be aligned to 8-byte memory lines, depending on the program. Such un-aligned block moves may require execution of many instructions to test for and handle non-aligned start and end conditions.

FIG. 1 shows prior-art approaches to moving a non-aligned data block. CPU 14 executes a program that contains instructions to read or load data from memory 10, and store or write the data into a second data structure in memory 12. Memory 12 may be another portion of a same physical memory as memory 10, or may be a different memory or even an I/O device of buffer for such an I/O device.

The source data structure in memory 10 is not aligned. It starts with the last 3 bytes in line L1, has three complete 8-byte lines, and ends with the first 2 bytes in line L5. When CPU 14 contains a reduced instruction set computer (RISC) instruction set that only allows for aligned loads and stores, many instructions may need to be included in the program to test for the non-aligned start and end of the memory structure, and to load or extract bytes from the partial lines L1 and L5.

The data loaded from memory 10 is temporarily stored in one or more destination registers in GPR 16. A subsequent store instruction reads the data from the register in GPR 16, and writes the data to the second data structure in memory 12. Several GPR registers may be used as data is transferred.

Some architectures, such as the MIPS architecture, provide a class of load/store instructions called load/store word left/right. These instructions provide to software a way to get a word of data for any alignment with just two memory access instructions. The instructions are also simple to implement since they require only one word aligned memory access. Some architectures allow for unaligned access at the cost of more complex implementations.

Another approach is to use a specialized direct-memory access (DMA) engine for the block transfer. DMA 18 is an additional block that may have block size and starting or ending addresses programmed by CPU 14. DMA 18 otherwise transfers data independently of CPU 14. Data is moved by DMA 18 from memory 10 to memory 12 using specialized DMA hardware. Of course, adding the DMA hardware may be undesirable. DMA does not allow for (1) loading and consuming/processing unaligned data; (2) creating and storing unaligned data; and (3) loading unaligned data, processing/modifying it, and storing unaligned data.

DMA 18 does not operate in response to a “DMA instruction” that is executed. Instead, DMA 18 is programmed with starting, ending, size, and other control information by instructions executing on CPU 14. The programming of the DMA adds overhead to program execution by CPU 14, and coordination between the DMA data transfer and the program on CPU 14 may be difficult.

What is desired are a streaming load and a streaming store instructions that can efficiently load, store, or move a block of data that is not aligned to memory-line boundaries.

### BRIEF DESCRIPTION OF THE DRAWINGS

FIG. 1 shows prior-art approaches to moving a non-aligned data block.

FIGS. 2A-E show execution of a series of streaming load instructions to read a non-aligned block of data.

FIGS. 3A-C show hardware to perform execution of the streaming load instruction.

FIGS. 4A-B show hardware to perform execution of the streaming store instruction.

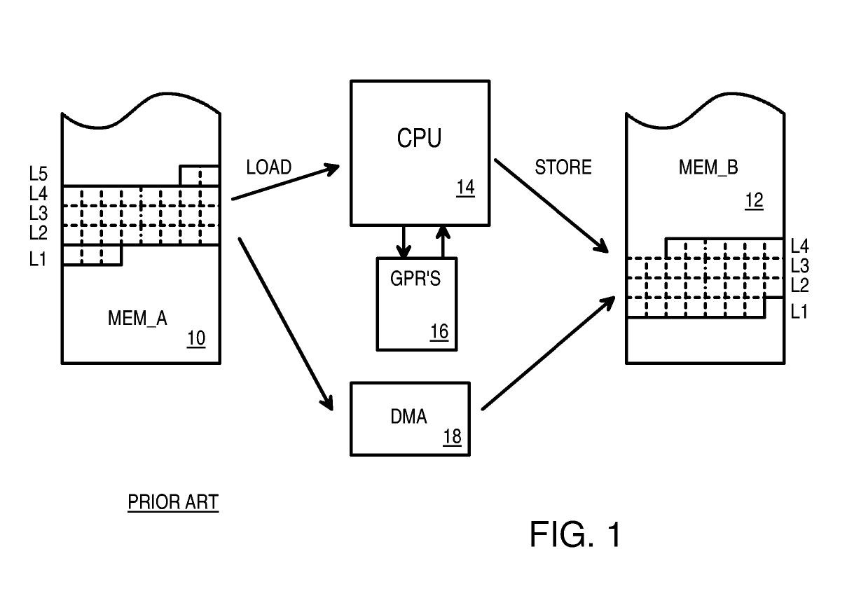

### DETAILED DESCRIPTION

The present invention relates to an improvement in unaligned load and store instructions. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventor has realized that specialized load and store instructions can be included in an instruction-set architecture to stream non-aligned blocks of data. The streaming load/store instructions are designed to be efficiently executed on a RISC processor pipeline with minimal additional hardware needed. Some additional limit checking is needed, and a scratch register for temporarily storing unused data for the next streaming load/store instruction is added.

The inventor has realized that aligned load/store instructions are very efficient because they only perform one aligned read or write per instruction. The streaming load/store instructions also perform only one read or write per instruction. Thus the streaming load/store instructions are highly efficient.

The inventor has further realized that the data may be read from the memory as aligned data lines, but written into the GPR's as non-aligned data. For streaming store instructions, data is read from the GPR's as non-aligned data, and written to memory as aligned data. Thus memory accesses are aligned, but GPR accesses are non-aligned.

Aligned data read from the memory is rotated to generate the non-aligned data. This non-aligned data is stored in a scratch register for use by the next streaming load/store instruction. The scratch register makes the un-used portion of the aligned-data memory read available to the next streaming load instruction to be executed. Thus the scratch register transfers some of the data read in a prior streaming load instruction to the next streaming load instruction.

The current streaming load instruction combines some data from the current aligned read with some non-aligned data read from memory in a previous streaming load instruction. The previously-read data is temporarily stored in the scratch register. The combination of data read from two different streaming load instructions is used to generate non-aligned data to store in the GPR destination register.

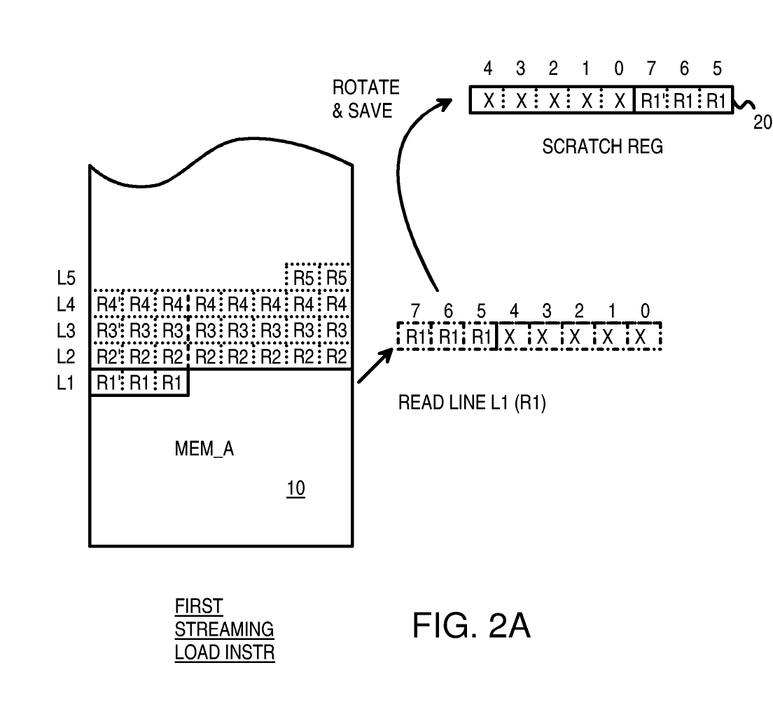

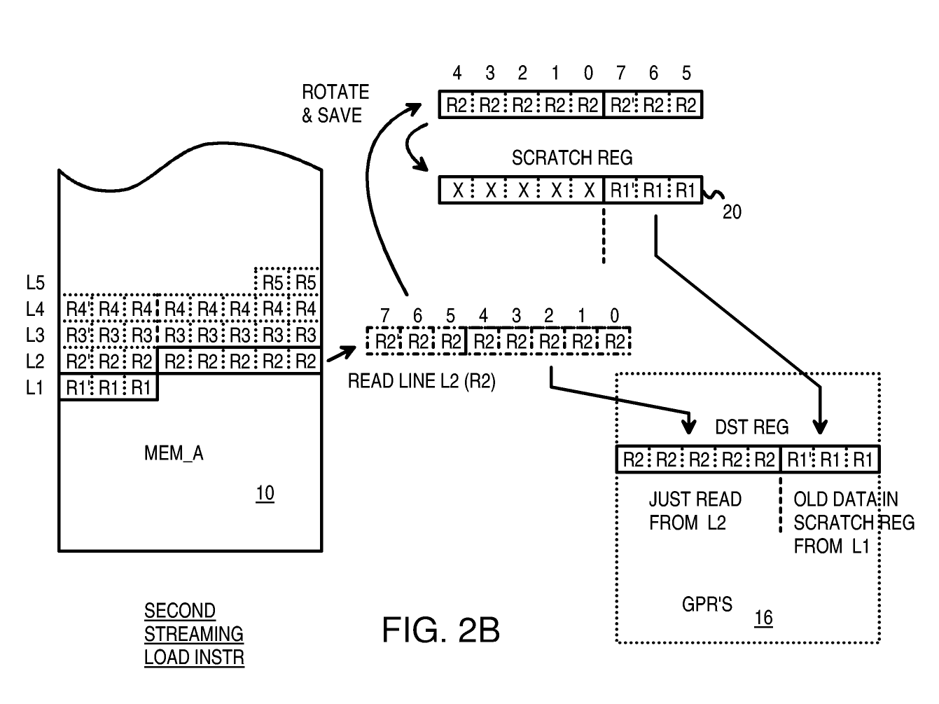

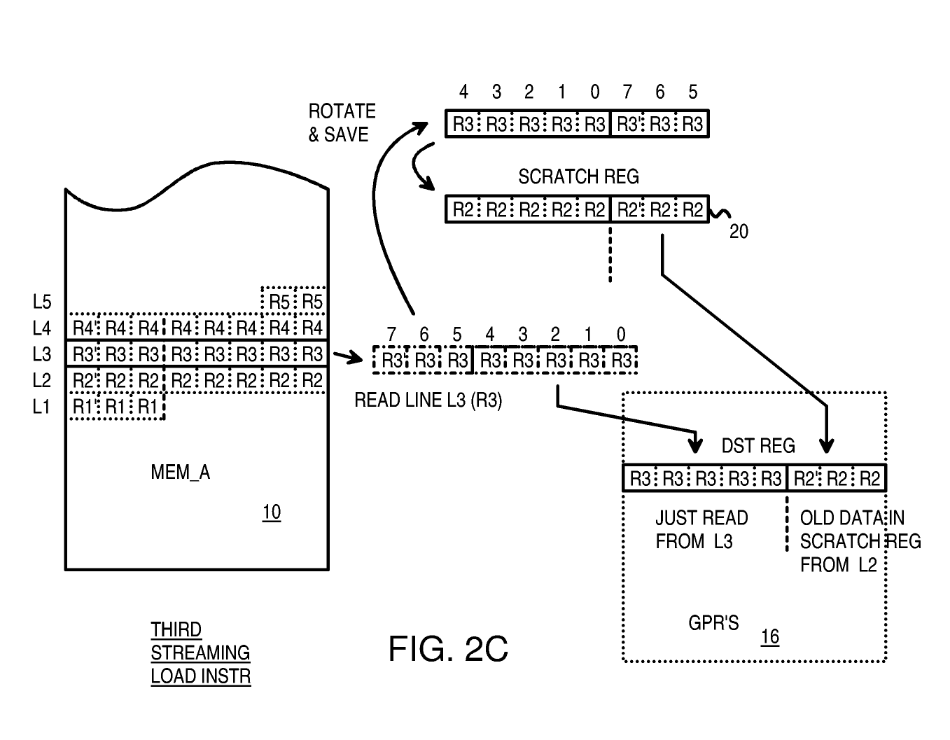

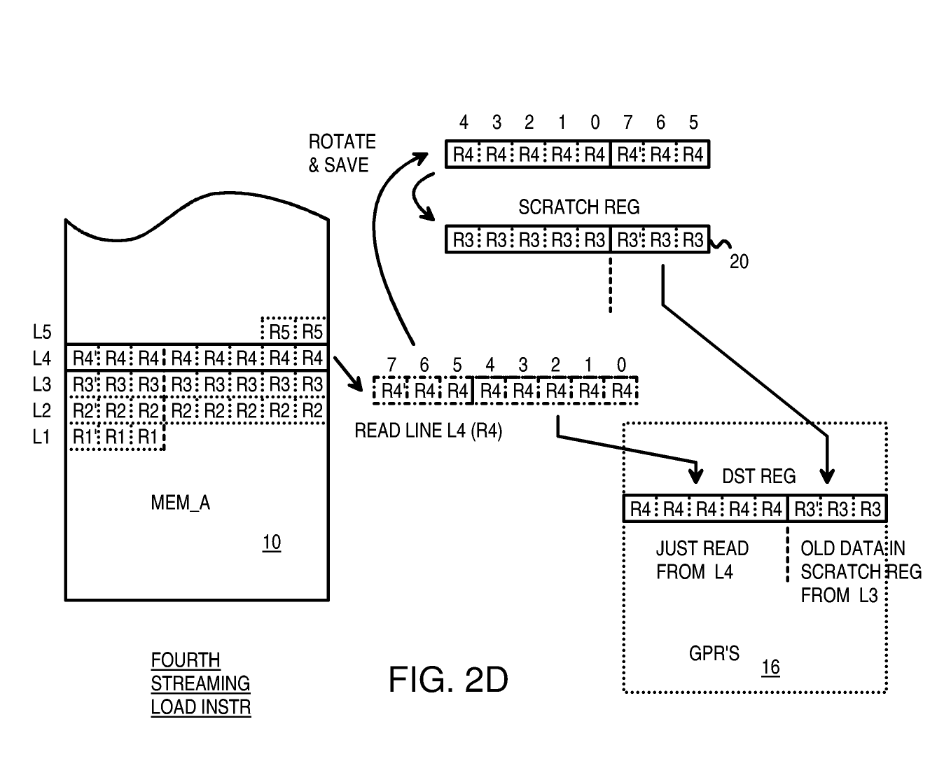

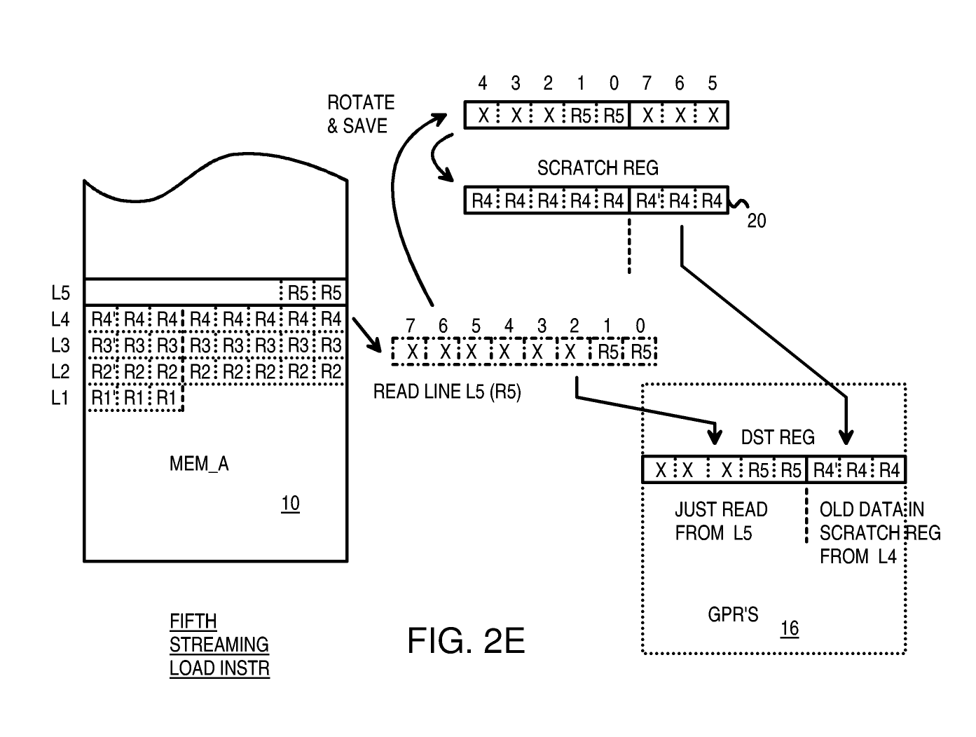

FIGS. 2A-E show execution of a series of streaming load instructions to read a non-aligned block of data. In FIG. 2A, a first streaming load instruction is executed. This first streaming load instruction is used to “prime” scratch register 20 with non-aligned data that will be used by the second streaming load instruction (FIG. 2B). Any data written to the destination register in GPR 16 (not shown in FIG. 2A) by the first streaming load instruction is ignored by the program.

The non-aligned block of data to be loaded from memory 10 has 3 bytes on first line L1, 8 bytes on middle lines L2, L3, L4, and two bytes on last line L5. Reading from memory 10 is performed as aligned reads. The first read operation reads bytes R1 from line L1. The second read operation reads 8 bytes R2 from line L2. The third read operation reads another 8 bytes R3 from line L3. The fourth read operation reads another 8 bytes R4 from line L4. The fifth and final read operation reads 2 bytes R5 from line L5.

Thus a total of only 5 aligned reads are needed to read the block from memory 10. Reading from memory 10 is very efficient. In contrast, prior-art non-aligned reads might require twice as many read operations. Two read operations are performed per non-aligned load instruction, a first read operation to first read some of the bytes (R1, R1, R1) from one memory line, and then a second read operation to read the remaining bytes (R2, R2, R2, R2, R2) from the next memory line.

The read operation performed by the first streaming load instruction reads line L1. The first five bytes of line L1, labeled X, are don't care bytes since they are not part of the data block. The aligned data read, R1, R1, R1, X, X, X, X, X, for bytes 7 to 0, is rotated by the byte offset to the first byte in the first line, or 5 bytes. This is considered a right rotate for little endian byte offsets. The description and figures show an embodiment using little endian format (LSB at lowest address).

The rotated data, X, X, X, X, X, R1, R1, R1, is stored in scratch register 20 for use by the next streaming load instruction shown in FIG. 2B. Scratch register 20 is “primed” or pre-loaded, for the next streaming load instruction. While data may be written into a GPR that is specified as the destination by an opcode for the first streaming load instruction, this data is ignored by the program and is not shown in FIG. 2A.

In FIG. 2B, the second streaming load instruction is being executed. The second line in memory 10 is read, with 8 bytes labeled R2. The high byte 7 is labeled R2′. The line read is rotated by the byte offset of the first byte in the memory block, 5 bytes, and is later stored into scratch register 20 upon completion of the instruction.

The destination register in GPR 16 is written with data spanning two lines in memory 10. The low 3 bytes in the destination register are loaded with the last 3 bytes R1 of first line L1, which are transferred from scratch register 20. The upper 5 bytes R2 from second line L2 are transferred from the rotated memory line L2 that was just read. The destination register is loaded as if an 8-byte read occurred, starting at the base address of byte 5 in line L1. This is shown as the boxed data in memory 10 that spans lines L1 and L2. Since data from line L1 was transferred from scratch register 20, only one memory read, for line L2, occurred during execution of the second streaming load instruction.

In FIG. 2C, the third streaming load instruction is being executed. The third line in memory 10 is read, with 8 bytes labeled R3. The high byte 7 is labeled R3′. The line read is rotated by the byte offset of the first byte in the memory block, 5 bytes, and is later stored into scratch register 20 upon completion of the instruction.

The destination register in GPR 16 is written with data spanning two lines in memory 10. The low 3 bytes in the destination register are loaded with the last 3 bytes R2 of second line L2, which are transferred from scratch register 20. The upper 5 bytes R3 from third line L3 are transferred from the rotated memory line L3 that was just read by this streaming load instruction.

The destination register is loaded as if an 8-byte read occurred, starting at the address of byte 5 in line L2. Since data from line L2 was transferred from scratch register 20, only one memory read, for line L3, occurred during execution of the third streaming load instruction.

In FIG. 2D, the fourth streaming load instruction is being executed. The fourth line in memory 10 is read, with 8 bytes labeled R4. The high byte 7 is labeled R4′. The line read is rotated by the byte offset of the first byte in the memory block, 5 bytes, and is later stored into scratch register 20 upon completion of the instruction.

The destination register in GPR 16 is written with data spanning two lines in memory 10. The low 3 bytes in the destination register are loaded with the last 3 bytes R3 of third line L3, which are transferred from scratch register 20. The upper 5 bytes R4 from fourth line L4 are transferred from the rotated memory line L4 that was just read by this streaming load instruction.

The destination register is loaded as if an 8-byte read occurred, starting at the address of byte 5 in line L3. Since data from line L3 was transferred from scratch register 20, only one memory read, for line L4, occurred during execution of the fourth streaming load instruction.

In FIG. 2E, the fifth and final streaming load instruction is being executed. The fifth line in memory 10 is read, with 8 bytes labeled R5. There are only 2 bytes in this line that are within the memory block; the bytes outside the block are labeled “X”. The line read is rotated by the byte offset of the first byte in the memory block, 5 bytes, and is later stored into scratch register 20 upon completion of the instruction.

The destination register in GPR 16 is again written with data spanning two lines in memory 10. The low 3 bytes in the destination register are loaded with the last 3 bytes R4 of third line L4, which are transferred from scratch register 20. The upper 2 bytes R5 from fifth line L5 are transferred from the rotated memory line L5 that was just read by this streaming load instruction.

The destination register is loaded as if a 5-byte read occurred, starting at the address of byte 5 in line L4, and ending at the last byte in the memory block. Since data from line L5 was transferred from scratch register 20, only one memory read, for line L5, occurred during execution of the fifth streaming load instruction.

Overall, 5 streaming load instructions were executed. Each streaming load instruction read only one aligned line in memory 10. The upper bytes in the line were transferred to the next streaming load instruction by temporarily being stored in scratch register 20. The destination GPR was loaded with rotated data that was a composite of data that was just read from the memory, and data that was stored in scratch register 20 and read by the previous streaming load instruction.

Even though the block began and ended at arbitrary locations that were not aligned to the memory lines, performance approaching that of an aligned block were achieved. An aligned memory block of the same size would have required 4 memory reads and 4 instructions, while the unaligned block was loaded with only one additional memory read, and one additional instruction.

Different destination registers may be written by each streaming load instruction, or the same register or group of registers may be over-written by successive streaming load instructions, such as when a streaming store instruction is executed immediately after each streaming load instruction.

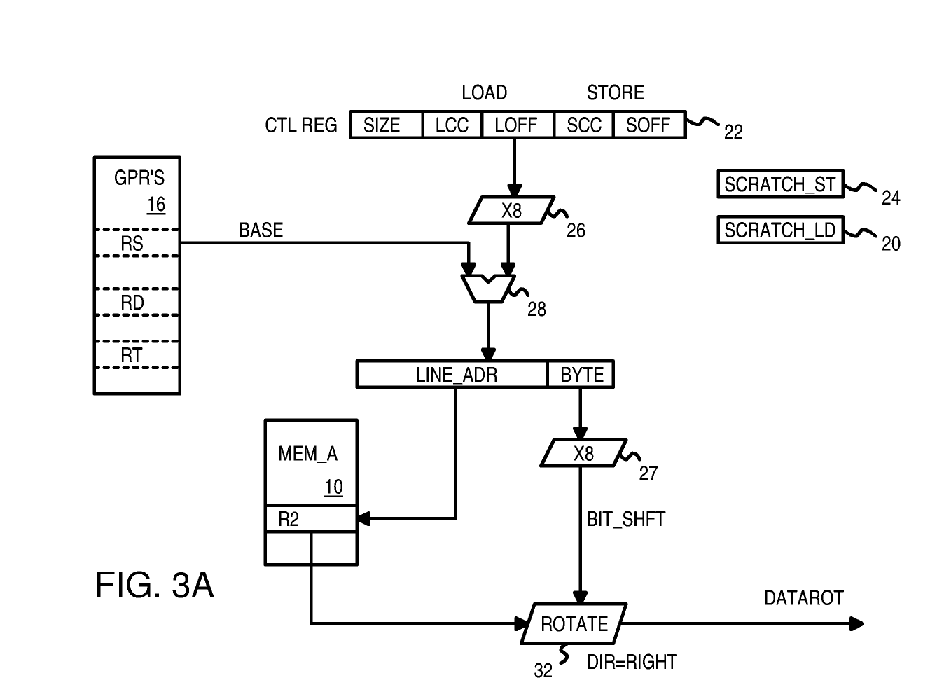

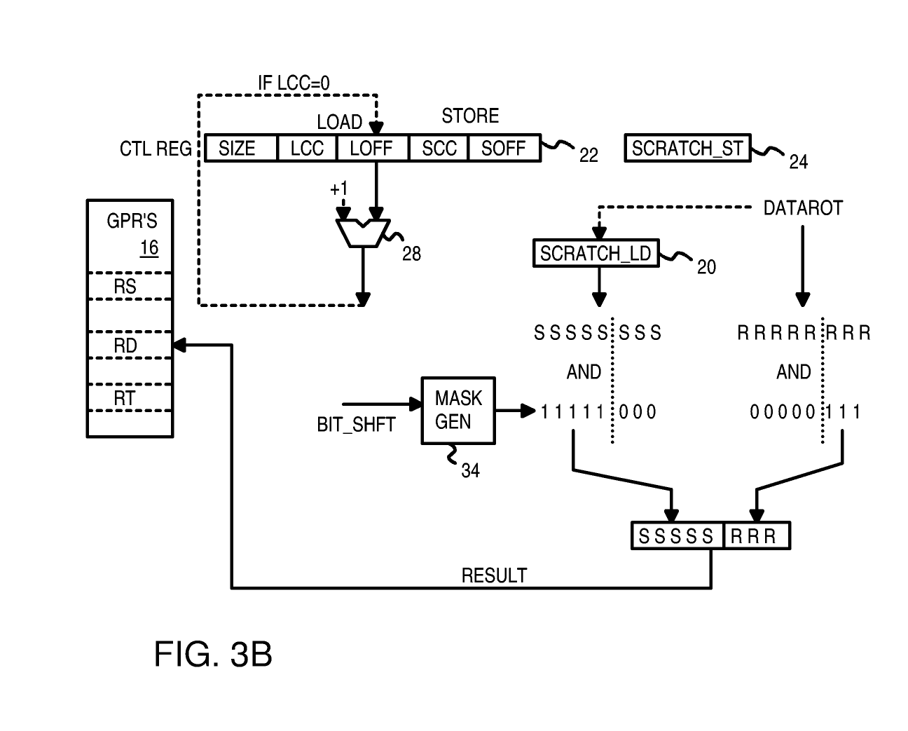

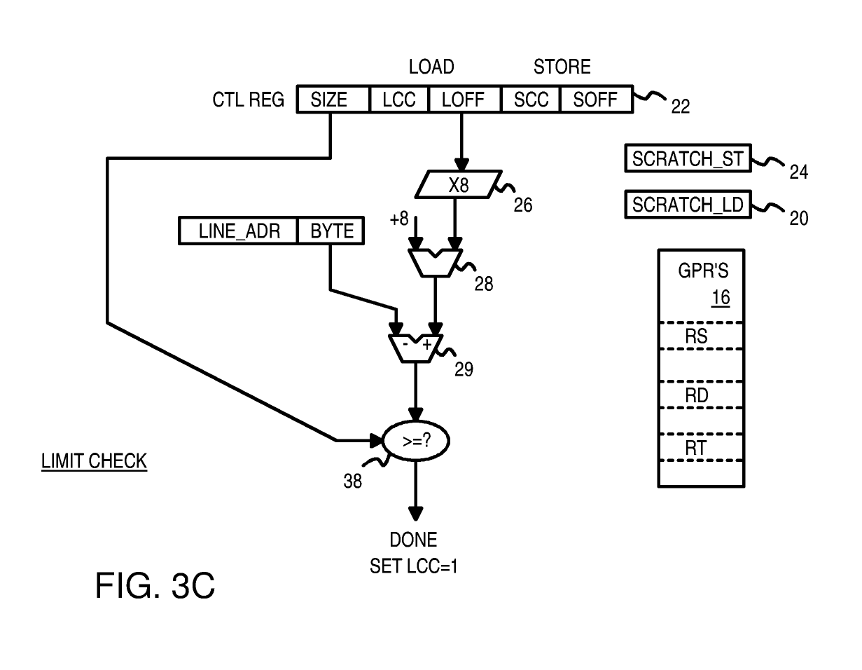

FIGS. 3A-C show hardware to perform execution of the streaming load instruction. In FIG. 3A, address generation, memory reading, and data rotating are shown. The base address BASE of the memory block is stored in source register RS in GPR 16, which is one of the register operands of the streaming load instruction. Control register 22 contains the size of the memory block in bytes, a load condition code LCC that is set when the end of the block is reached, and a load offset LOFF, that indicates the current line number within the block that is being read. For example, LOFF is 0 for line L1, 1 for line L2, 2 for line L3, 3 for line L4, and 4 for line L5 in FIGS. 2A-E.

Control register 22 also stores a condition code SCC and an offset SOFF for streaming store instructions. A separate store scratch register 24 allows both streaming load instructions and streaming store instructions to be alternately executed when transferring a large block from one memory to another. The destination GPR of the streaming load instruction becomes the data-source register of the streaming store instruction for the overlapping load/store transfer.

The load offset LOFF is multiplied or scaled by the number of bytes per memory line (8 in this example) by multiplier 26 and then added to the base address from the source register by adder 28 to generate the virtual address. The last 3 bits of the virtual address from adder 28 are the byte within the line, or byte address, while the upper address bits are the line address. The upper address bits are sent to memory 10 with the lower address bits zeroed out so that the whole line in memory 10 is read, starting from the first byte in the memory line.

The byte address is multiplied by the number of bits per byte (8) by multiplier 27 to generate a bit shift that is applied to data rotator 32. Data rotator 32 rotates the 8-byte memory line by the bit shift to generate the rotated data, DATAROT.

In FIG. 3B, the rotated data just read from memory is combined with data read by the previous streaming load instruction and stored in scratch register 20 to generate the result data that is loaded into the destination GPR. The bit shift generated from the byte address is used by mask generator 34 to generate data masks. A first mask has ones in the upper bytes and selects the upper bytes from scratch register 20, while the second mask has ones in the lower bytes and selects the lower bytes from the rotated data DATAROT. The selected rotated data bytes, labeled R, were read by the current streaming load instruction, while the selected stored data bytes, labeled S, were read by the prior streaming load instruction and stored in scratch register 20.

The composite result is written into the destination register RD in GPR 16. The destination register can be identified by a register operand in the streaming load instruction. The composite result can be generated by ANDing the data bits with the bit mask from mask generator 34.

The rotated data just read from the memory, DATAROT, is then loaded into scratch register 20 for use by the next streaming load instruction. When the end of the block has not been reached, the load offset LOFF is incremented by adder 28.

FIG. 3C shows limit checking that detect when the end of the memory block has been reached. Streaming load instructions continue to be executed until the final line in the block is reached. The offset address can be checked for each streaming load instruction to detect the endpoint.

The current load offset LOFF is multiplied by the line size, 8, by multiplier 26 and added to one by adder 28 to get the line offset for the next line. This represents the number of bytes in all the lines that have been loaded, plus one more line. Then the byte address is subtracted by adder 29. This represents the actual number of bytes read up to and including execution of the current streaming load instruction.

When the number of bytes read is larger than or equal to the block size, then the whole block has been read. The end of the block has been reached. Any further streaming load instructions should be disabled. Comparator 38 compares the block size SIZE from control register 22 to the actual number of bytes read from adder 29. When number of bytes read is equal to or exceeds the block size from control register 22, then the load condition code LCC is set.

Incrementing of the load offset LOFF may be disabled when LCC is set to prevent advancing beyond the memory block. Memory reads could also be disabled when LCC is set, or the same last line could be re-read by disabled instructions.

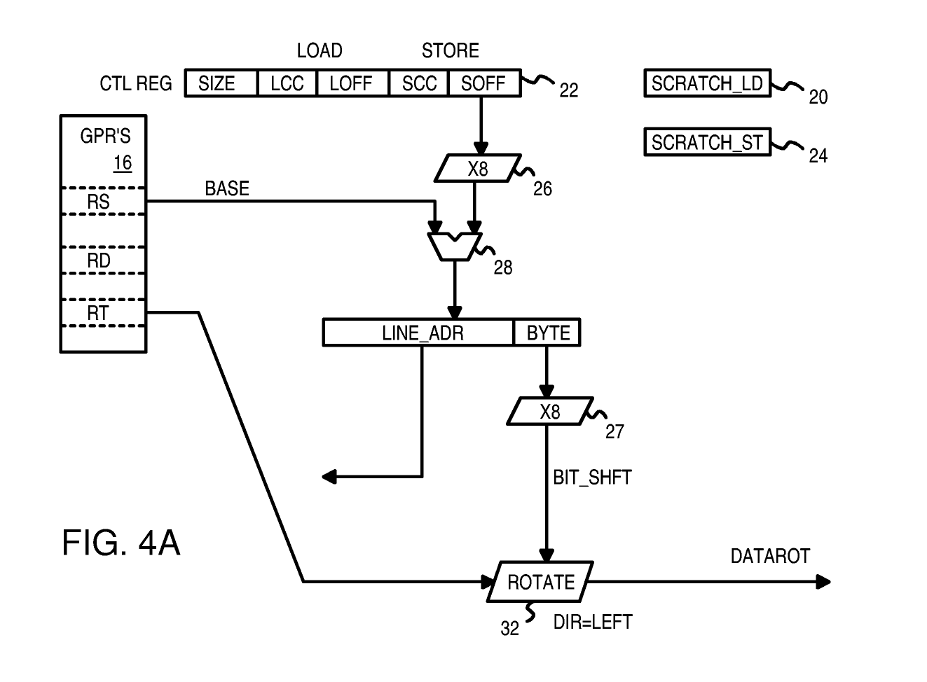

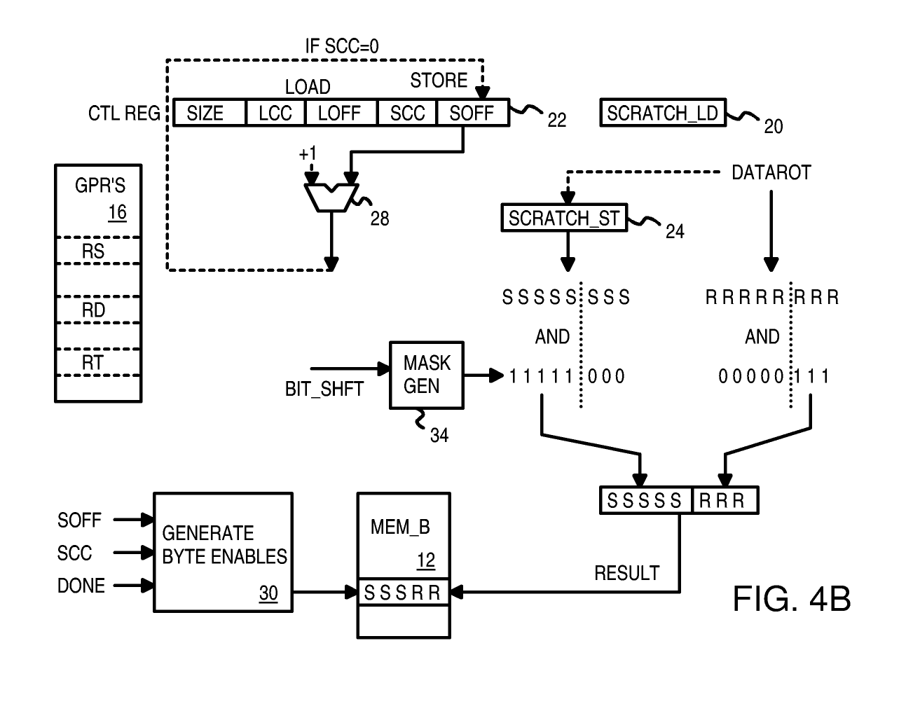

FIGS. 4A-B show hardware to perform execution of the streaming store instruction. In FIG. 4A, address generation, GPR register reading, and data rotating are shown. The base address BASE of the memory block is stored in source register RS in GPR 16, which is one of the register operands of the streaming store instruction. Control register 22 contains the size of the memory block in bytes, a store condition code SCC that is set when the end of the block is reached, and a store offset SOFF, that indicates the current line number within the block that is being written. For example, SOFF is 0 for line L1, 1 for line L2, 2 for line L3, 3 for line L4, and 4 for line L5 in FIGS. 2A-E.

The store offset SOFF is multiplied or scaled by the number of bytes per memory line (8 in this example) by multiplier 26 and then added to the base address from the source register by adder 28 to generate the virtual address. The last 3 bits of the virtual address from adder 28 are the byte within the line, or byte address, while the upper address bits are the line address. The upper address bits are sent to memory 12 (FIG. 4B) with byte enables to select which bytes to write.

The byte address is multiplied by the number of bits per byte (8) by multiplier 27 to generate a bit shift that is applied to data rotator 32. Data rotator 32 rotates the 8-byte line read from the data-source register in GPR 16 by the bit shift to generate the rotated data, DATAROT. Data is rotated in the opposite direction for stores than for loads, since the source data in GPR 16 is aligned, while the memory data may be un-aligned.

The destination GPR of the streaming load instruction may become the data-source register RT of the streaming store instruction for the overlapping store/store transfer. Data-source register RT may be one of the register operands of the streaming store instruction.

In FIG. 4B, the rotated data just read from the data-source GPR is combined with data read from the data-source GPR by the previous streaming store instruction and stored in scratch register 24 to generate the result data that is written to memory.

The bit shift generated from the byte address is used by mask generator 34 to generate data masks. A first mask has ones in the upper bytes and selects the upper bytes from scratch register 24, while the second mask has ones in the lower bytes and selects the lower bytes from the rotated data DATAROT. The selected rotated data bytes, labeled R, were read from GPR 16 by the current streaming store instruction, while the selected stored data bytes, labeled S, were read from GPR 16 by the prior streaming store instruction and stored in scratch register 24.

The composite result is written to one aligned memory line in memory 12. The composite result can be generated by ANDing the data bits with the bit mask from mask generator 34. The line address applied to memory 12 was generated as the upper address bits for the virtual address generated in FIG. 4A.

The rotated data just read from GPR 16, DATAROT, is then written into scratch register 24 for use by the next streaming store instruction. When the end of the block has not been reached, the store offset SOFF is incremented by adder 28.

Lines in the middle of the memory block have all 8 bytes written, and have all 8 bytes enables active. However, the first and last lines in the memory block may be partial lines. For those endpoint lines, byte-enable generator 30 generates byte enables that correspond only to bytes within the memory block. This prevents writing outside the non-aligned memory block.

Byte-enable generator 30 can receive the byte address, block size, current offset SOFF, and condition codes and other signals to determine which byte enables to activate. Logic such as described in the pseudo code shown below for the streaming store instruction may be implemented in hardware to implement byte-enable generator 30.

Limit checking that detects when the end of the memory block has been reached may be implemented in a manner similar to that described in FIG. 3C for streaming load instructions, but using the store offset SOFF and setting the store condition code SCC.

Any future streaming store instructions are disabled from writing to memory when SCC is set. This prevents writing past the end of the memory block. Incrementing of the store offset SOFF can also be disabled when SCC is set to prevent advancing beyond the memory block. Memory writes could also be disabled when SCC is set, or the same last line could be re-write by disabled instructions.

While little endian format has been shown in the examples above, the invention can also be practiced using the big endian format, with the most-significant-byte (MSB) at the lowest address in the line. The pseudo-code example below shows an implementation using big endian.

Shown below are pseudo code examples of logic for a streaming load instruction, and an example of loading of a non-aligned data block by the streaming load instruction. LOAD64 performs an 8-byte read from memory, while STORE8 writes one byte to memory. The following terms are used:

GPR[rs]: register file source register, contains the base address.

GPR[rd]: destination register for data, 8-bytes

GPR[rt]; source register for data, 8-bytes

rotLeft ( . . . ): does a byte rotate left

rotRight( . . . ): does a byte rotate right

StreamCtl: Control register for the streaming load/store, contains:

Size: Size of data stream, in bytes

LCC: Streaming load condition code, 1=done

LOff: Streaming load offset, in 8-byte lines

SCC: Streaming store condition code, 1=done

SOff: Streaming store offset, in 8-byte lines

ScratchLoad: Data register for streaming load, 8-bytes

ScratchStore: Data register for streaming store, 8-bytes

Below is an example of pseudo-code to emulate a streaming load instruction: Ids8 rd, [rs]

base = GPR[rs];
va = base + (StreamCtl[LOff] * 8);
data = LOAD64(va & ˜0×7);
bitShift = (va & 0×7) * 8;
dataRot = rotLeft(data, bitShift);
// Done if highest memory byte goes up to or just past the size
hiMemByte = (StreamCtl[LOff] * 8) + 8 − (va & 0×7);
done = hiMemByte >= StreamCtl[Size];
byteMask = −1 << bitShift;
result = (ScratchLoad & byteMask) | (dataRot & ˜byteMask);
if (done) {

StreamCtl[LCC] = 1;

} else {

// not done, set up for next Ids8
StreamCtl[LOff] = StreamCtl[LOff] + 1;

}
ScratchLoad = dataRot;
GPR[rd] = result;

Example of a streaming load of 6 bytes starting at byte 3:

| rA = 3 | |
|---|---|
| Size = 6 | |
| LOff = 0, LCC = 0 | |
| ScratchLoad = | pqrstmno |
| memory = | 0123456789abcdef |

| | |
|---|---|
| rX | = ??????? |

Ids8 rX [rA]

| LOff = 8, LCC = 0 | | |
|---|---|---|
| rX | = | pqrst012 |

| | |
|---|---|
| ScratchLoad = | 34567012 |

Ids8 rX [rA]

| LOff = 8, LCC = 1 | | |
|---|---|---|
| rX | = | 3456789a |

| | |
|---|---|
| ScratchLoad = | bcdef89a |

For the streaming store instruction in the code below, the bytes are described as being separately enabled and written using 8-bit STORE8 operations, in a physical implementation these STORE8 operations could be combined so that an entire line of up to 8 bytes are written at a time in a single write memory access, with byte enables selecting which of the 8 bytes are being written. Below is pseudo-code to emulate a streaming store instruction: sts8 [rs], rt

base = GPR[rs];
val = GPR[rt];
va = (base) + (StreamCtl[SOff] * 8);
bitShift = (va & 0×7) * 8;
valRot = rotRight(val,bitShift);
// Done if highest memory byte goes up to or just past the size
hiMemByte = (StreamCtl[SOff] * 8) + 8 − (va & 0×7);
done = hiMemByte >= StreamCtl[Size];
if (StreamCtl[SCC] == 1) {

// already at past the end of stream, store no bytes
StartByteEn = 8;

} else {

if (StreamCtl[SOff] == 0) {

// fist store, start at byte offset in va
StartByteEn = va & 0×7;

} else {

// start at byte 0
StartByteEn = 0;

}

}
if (done) {

// in the final double word, only store bytes left
EndByteEn = (va + StreamCtl[Size] − 1) & 0×7;

} else {

// store to last byte in 8-byte word
EndByteEn = 7;

}
byteMask = (bitShift == 0) ? 0 : (−1 << (64−bitShift));
data = (ScratchStore & byteMask) | (valRot & ˜byteMask);
// Only store bytes that have been enabled
for (byte = StartByteEn; byte <= EndByteEn; byte = byte + 1) {

STORE8((va & ˜0×7)+byte,getByte(data,byte));

}
if (done) {

StreamCtl[SCC] = 1;

} else {

// not done, set up for next sts8;
StreamCtl[SOff] = StreamCtl[SOff] + 1;

}
ScratchStore = valRot;

Example of a streaming store of 6 bytes starting at byte 3:

| rA = 3 | |
|---|---|
| Size = 6 | |
| SOff = 0, SCC = 0 | |
| ScratchStore = | ???????? |

| | |
|---|---|
| memory = | 0123456789abcdef |

| | |
|---|---|
| rX = | MNOPQRST |

sts8 [rA] rX

| SOff = 8, SCC = 0 | |
|---|---|
| memory = | 012MNOPQ89abcdef |

| | |
|---|---|
| ScratchStore = | RSTMNOPQ |

sts8 [rA] rX

| SOff = 8, SCC = 1 | |
|---|---|
| memory = | 012MNOPQR9abcdef |

| | |
|---|---|
| ScratchStore = | RSTMNOPQ |

The usefulness of these streaming instructions can be demonstrated in the following block move code sequences.

The following code performs a block copy and might be part of a byte copy function. Note that this code loop works for any arbitrary block size and source and destination address alignment. All edge conditions are handled with minimal loop setup and cleanup. On a simple single issue CPU with a 2 cycle load-to-use penalty and 64-bit registers, this loops copies 8 bytes in 5 cycles

| # RSrc = source address | | |
|---|---|---|
| # RDst = destination address | | |
| # RSize = size of byte copy | | |
| | mtcr | StreamCtl, RSize |
| | Ids8 | Rtmp, [RSrc] # primes ScratchLoad |
| 1: | Ids8 | Rtmp, [RSrc] |
| | sts8 | [RDst], Rtmp |
| | bcc0 | LCC, 1b |

The following code also performs a block copy but unrolls the loop and reschedules the instructions to avoid pipeline hazards and penalties like a load-to-use delay. Note that there is no extra code to handle the edge conditions or provide early out detection. The lds8 and sts8 instructions have independent control logic that cause them to be “disabled” and stop advancing through memory once the block size has been reached, even if they continue to be executed. On a simple single issue CPU with a 2 cycle load-to-use penalty and 64-bit registers, this loops copies 16 bytes in 5 cycles:

| # RSrc = source address | | |
|---|---|---|
| # RDst = destination address | | |
| # RSize = size of byte copy | | |
| | mtcr | StreamCtl, RSize |
| | Ids8 | Rtmp1, [RSrc] # primes ScratchLoad |
| | Ids8 | Rtmp1, [RSrc] |
| | Ids8 | Rtmp2, [RSrc] |
| 1: | sts8 | [RDst], Rtmp1 |
| | sts8 | [RDst], Rtmp2 |
| | Ids8 | Rtmp1, [RSrc] |
| | Ids8 | Rtmp2, [RSrc] |
| | bcc0 | SCC, 1b |

Rather than testing and looping on the load condition code, this loop ends with store instructions and loops on the store condition code. Data is alternately loading into two temporary registers rather than one temporary register.

### Alternate Embodiments

Several other embodiments are contemplated by the inventor. For example more than 8 bytes could be in each memory line, such as 16 or 32 bytes per line, and the scaling could be adjusted for the larger line size. Smaller line sizes such as 4 bytes could also be used. While sharing of adders, multipliers, and other blocks has been shown, separate hardware blocks may be provided. The unaligned instructions may be implemented for a little-endian (least-significant byte at lowest address), or big-endian architectures (most-significant byte at lowest address).

While the base address, destination, and data-source have been described as register operands in the instructions, these registers could be pre-defined. For example, the base address could always be located in the first GPR register, or in a special address register, or in some other location that does not have to be specified for each instruction. The scratch registers could be general purpose registers. This may require an extra register file write.

The operands may be somewhat different for different instruction variants. For example, condition codes could be stored in a GPR rather than in control register 22. Another operand could identify the GPR with the condition codes. Rather than have separate condition codes for store and load, one shared condition code could be used.

An operand field may designate a register that stores a pointer to another register or to a memory location. Additional or fewer operands can also be substituted for any or all of the instruction variants. Other GPR registers could be used for the different operands such as the offset, data-copy length, etc. rather than using control register 22. Offsets can be from the beginning of the data, or from the beginning of the entry, or from the beginning of a memory section or an offset from the beginning of the entire cache. Other offsets or absolute addresses could be substituted. Offsets could be byte-offsets, bit-offsets, word-offsets, or some other size. Increments of the offset could be negative increments or increments other than one. The byte offset could be calculated once at the start of a block and stored rather than being re-generated.

Background state machines or complex micro-coded specialty hardware to execute the streaming load/store instructions are not needed. The streaming load/store instructions can be executed in the normal pipeline. Simple logic to detect and handle endpoint conditions can be provided, and a control register for the streaming load/store instructions, and scratch registers, are added to the normal pipeline hardware.

Execution may be pipelined, where several instructions are in various stages of completion at any instant in time. Complex data forwarding and locking controls can be added to ensure consistency, and pipestage registers and controls can be added. Update bits and locks may be added for pipelined execution when parallel pipelines or parallel processors access the same memory. Adders/subtractors can be part of a larger unit-logic-unit (ALU) or a separate address-generation unit. A shared adder may be used several times for generating different portions of addresses rather than having separate adders. The control logic that controls computation and execution logic can be hardwired or programmable such as by firmware, or may be a state-machine, sequencer, or micro-code.

A variety of instruction-set architectures, both RISC and CISC, may benefit from addition of the streaming load/store instruction. A wide variety of instruction formats may be employed. Direct and indirect, implicit or explicit operands and addressing may be used. The processor pipeline may be implemented in a variety of ways, using various stages.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A streaming micro-processor comprising:
an instruction decoder for decoding instructions in a program being executed by the streaming micro-processor, the instructions including a streaming-load instruction;
a register file containing registers that store operands operated upon by the instructions, the registers being identified by operand fields in the instructions decoded by the instruction decoder or are inherently identified by a pre-defined definition of the instructions;
a memory-access unit for accessing aligned lines in a memory, each aligned line having a pre-defined number of bytes and starting and ending at multiples of the pre-defined number of bytes;
a control register that stores an offset that indicates an aligned line within a block in the memory;
a scratch register that stores prior-read data that was read in a prior streaming-load instruction for use by a current streaming-load instruction;
an address generator for generating a line address to the memory-access unit, the address generator receiving the offset from the control register and a base address that indicates a base location of the block in the memory;
a byte shift generator that receives the base address and generates a byte shift from a byte offset of the base address within an aligned line in the memory;
a data rotator that receives an aligned line read by the memory-access unit in response to the line address from the address generator and rotates the aligned line by an amount determined by the byte shift to generate a rotated line;
a data combiner, receiving the rotated line from the data rotator and the prior-read data from the scratch register, for combining first bytes from the rotated line with second bytes from the prior-read data to generate result data having the pre-defined number of bytes; and
a result writer that writes the result data generated by the data combiner into a result register,
whereby the result data includes bytes read by the current streaming-load instruction and bytes read by the prior streaming-load instruction.

2. The streaming micro-processor of claim 1 further comprising:
an instruction-completion unit that advances the offset to point to a next aligned line in the block and that writes the rotated line from the data rotator into the scratch register, after the data combiner has generated the result data.

3. The streaming micro-processor of claim 2 further comprising:
a limit checker, receiving a block size for the block in memory and receiving the offset, for detecting when an end of the block is reached, and for disabling the instruction-completion unit from advancing the offset when the end of the block is detected.

4. The streaming micro-processor of claim 1 wherein each streaming-load instruction executed performs no more than one read of one aligned line in the memory, but writes results from up to two aligned lines in the memory.

5. The streaming micro-processor of claim 1 further comprising:
a mask generator, receiving the byte shift from the byte shift generator, for generating a first mask and a second mask, the first mask selecting the first bytes from the rotated line and the second mask selecting the second bytes from the prior-read data;
wherein the data combiner receives the first mask and the second mask from the mask generator.

6. The streaming micro-processor of claim 3 wherein the control register stores the block size, the offset, and a condition code that is set when the limit checker detects the end of the block.

7. The streaming micro-processor of claim 1 wherein the instruction decoder is also for decoding a streaming-store instruction;
wherein the control register is a combined control register that stores the block size, the offset for streaming-load instructions, and a store offset for the streaming-store instruction.

8. The streaming micro-processor of claim 1 wherein the instruction decoder is also for decoding a streaming-store instruction;
further comprising:
a store scratch register that stores prior data that was written into the register file by a streaming-load instruction and read from the register file by a prior streaming-store instruction, the prior data for use by a current streaming-store instruction;
wherein the address generator receives a store offset and a store base address for generating a store line address to the memory-access unit for an aligned line in a second block in a memory,
wherein the byte shift generator receives the store base address and generates a store byte shift from a store byte offset of the store base address within an aligned line in the memory;
wherein the data rotator receives loaded data from a data-source register in the register file that was written into the register file by a streaming-load instruction, the data rotator rotates the loaded data by an amount determined by the byte shift to generate a rotated store line;
the data combiner receives the rotated store line from the data rotator and the prior data from the store scratch register, and combines first bytes from the rotated store line with second bytes from the prior data to generate store data having the pre-defined number of bytes;
wherein the memory-access unit writes the store data into the second block in the memory in response to the store line address from the address generator,
whereby the store data includes bytes read from the register file by the current streaming-store instruction and bytes read from the register file by the prior streaming-store instruction.

9. The streaming micro-processor of claim 1 wherein the result register is in the register file and is identified by a destination operand in the streaming-load instruction; and
wherein the base address is stored in a source register in the register file and is identified by a source operand in the streaming-load instruction.

10. A computerized method for executing a streaming-load instruction comprising:
decoding instructions for execution by a processor including decoding the streaming-load instruction that contains an opcode that specifies a streaming-load operation that reads from a memory;
decoding a first operand field in the streaming-load instruction and a result field in the streaming-load instruction, the first operand field specifying a first register that contains a base address that locates a block in the memory for loading by the streaming-load instruction while the result field specifies a result register that a result of the streaming-load operation is to be written to;
generating a memory address from the base address and from an offset within the block;
forming a line address from upper address bits in the memory address, wherein a byte address is formed from lower address bits in the memory address;
wherein the memory contains a plurality of aligned lines, each aligned line having a maximum number of bytes that are readable in a single memory access, wherein aligned lines that are fully within the block contain the maximum number of bytes and are aligned to multiples of the maximum number of bytes;
wherein the line address identifies an aligned line in the plurality of aligned lines in the memory, and the byte address identifies a byte within an aligned line;
using the line address to read the maximum number of bytes from an aligned line from the block in memory;
rotating the aligned line read from the memory to form a rotated line, wherein the aligned line is rotated by an amount determined by the byte address;
forming a result by combining bytes from the rotated line with bytes from a stored line in a scratch register, wherein the bytes in the stored line in the scratch register were previously read from the memory by a prior streaming-load instruction that was executed before a current streaming-load instruction that is being executed;
storing the result into the result register;
storing at least a portion of the rotated line into the scratch register for use by a following streaming-load instruction; and
incrementing the offset to point to a next aligned line in the memory,
whereby the maximum number of bytes that are readable in a single memory access are read for each streaming-load instruction by reading an aligned line in the memory.

11. The computerized method of claim 10 wherein forming the result by combining bytes comprises combining by concatenating a first group of bytes from the rotated line with a second group of bytes from the stored line in the scratch register;
wherein the first group and the second group are non-overlapping bytes.

12. The computerized method of claim 10 further comprising:
dividing the rotated line into a first portion and a second portion using the byte address to identify a division location between the first portion and the second portion;
wherein storing at least a portion of the rotated line into the scratch register for use by a following streaming-load instruction comprises storing at least the second portion;
wherein forming the result comprises forming the result using the first portion of the rotated line and the second portion of the stored line, wherein the first portion is from the current streaming-load instruction while the second portion is from the prior streaming-load instruction.

13. The computerized method of claim 10 wherein the prior streaming-load instruction, the current streaming-load instruction, and the following streaming-load instruction are in a sequence of streaming-load instructions that perform a number of memory read accesses that is no more than two plus a number of aligned lines fully within the block,
whereby the number of memory read accesses is limited to two more than the number of aligned lines fully within the block.

14. The computerized method of claim 10 further comprising:
detecting an end of the block by performing a limit check that receives a size of the block and the offset.

15. The computerized method of claim 14 further comprising:
disabling incrementing the offset to point to the next aligned line in the memory when the end of the block is detected,
whereby memory over-runs are avoided by disabling offset advancing.

16. The computerized method of claim 15 further comprising:
setting a condition code when the end of the block is detected.

17. The computerized method of claim 10 further comprising:
executing streaming-store instructions that read data from the result register of the streaming-load instructions and write the data to a second memory block by rotating the data in an amount determined by the byte address, and combining bytes from a store scratch register that was read from the result register by a prior streaming-store instruction with bytes from a current streaming-store instruction to form data to write to the second memory block within one aligned line,
whereby streaming-store instructions are also executed that use the store scratch register to pass data to a next streaming-store instruction.

18. A streaming processor comprising:
decode means for decoding instructions including decoding a streaming-load instruction that contains an opcode that specifies a streaming-load operation from a load memory block into a destination register and for decoding a streaming-store instruction that contains an opcode that specifies a streaming-store operation from a data-source register to a store memory block;
wherein the destination register of the streaming-load instruction can be programmed to be a same register as the data-source register of the streaming-store instruction;
register file means for storing program data, the register file means containing registers accessible by execution of instructions decoded by the decode means, the register file means including the destination register and the data-source register;
load scratch register means for storing prior-load data from a prior streaming-load instruction for use by a current streaming-load instruction;
address generation means, receiving a base address for the load memory block and receiving a load offset within the load memory block, for forming a load line address of an aligned line within the load memory block, and a byte offset within the aligned line;
memory read means for reading a maximum number of bytes from an aligned line from the load memory block;
load rotate means for rotating the aligned line that was read from the load memory block to form a rotated line, wherein the aligned line is rotated by an amount determined by the byte offset;
result combining means for forming a load result by combining bytes from the rotated line with bytes from the prior-load data in the load scratch register means to generate the load result;
result means for storing the load result into the destination register in the register file means;
scratch over-write means for storing at least a portion of the rotated line into the load scratch register means for use by a following streaming-load instruction; and
increment means for incrementing the load offset to point to a next aligned line in the load memory block,
whereby the maximum number of bytes that are readable in a single memory access are read for each streaming-load instruction by reading an aligned line in the load memory block.

19. The streaming processor of claim 18 further comprising:
store scratch register means for storing prior-store data from a prior streaming-store instruction for use by a current streaming-store instruction;
store address generation means, receiving a store base address for the store memory block and receiving a store offset within the store memory block, for forming a store line address of an aligned line within the store memory block, and a store byte offset within the aligned line;
store register read means for reading current store data from the data-source register in the register file means;
store rotate means for rotating the current store data to form a rotated store line, wherein the current store data is rotated by an amount determined by the store byte offset;
store combining means for forming a store result by combining bytes from the rotated store line with bytes from the prior-store data in the store scratch register means to generate the store result;
memory write means for writing the store result into one aligned line in the store memory block;
scratch store over-write means for storing at least a portion of the rotated store line into the store scratch register means for use by a following streaming-store instruction; and
increment means for incrementing the store offset to point to a next aligned line in the store memory block,
whereby the streaming-store instruction writes to one aligned line in the store memory block for each streaming-store instruction.

20. The streaming processor of claim 19 further comprising:
control register means for storing streaming control fields, the control register means storing a size of the load memory block, the load offset, the store offset, a load condition code that is set when an end of the load memory block is reached, and a store condition code that is set when an end of the store memory block is reached.

21. A streaming-store micro-processor comprising:
an instruction decoder for decoding instructions in a program being executed by the streaming-store micro-processor, the instructions including a streaming-store instruction;
a register file containing registers that store operands operated upon by the instructions, the registers being identified by operand fields in the instructions decoded by the instruction decoder or are inherently identified by a pre-defined definition of the instructions;
a memory-access unit for writing aligned lines in a memory, each aligned line having a pre-defined number of bytes and starting and ending at multiples of the pre-defined number of bytes;
a control register that stores an offset that indicates an aligned line within a block in the memory;
a scratch register that stores prior data that was read from the register file by a prior streaming-store instruction, the prior data for use by a current streaming-store instruction;
an address generator for generating a line address to the memory-access unit, the address generator receiving the offset from the control register and a base address that indicates a base location of the block in the memory;
a byte shift generator that receives the base address and generates a byte shift from a byte offset of the base address within an aligned line in the memory;
a data rotator that receives loaded data from a data-source register in the register file, the data rotator rotating the loaded data by an amount determined by the byte shift to generate a rotated line; and
a data combiner, receiving the rotated line from the data rotator and the prior data from the scratch register, for combining first bytes from the rotated line with second bytes from the prior data to generate store data having the pre-defined number of bytes;
wherein the memory-access unit writes the store data into the block in the memory in response to the line address from the address generator,
whereby the store data includes bytes read from the register file by the current streaming-store instruction and bytes read from the register file by the prior streaming-store instruction.
